(19) United States
(12) Patent Application Publication
(10) Pub. No.: US 2013/0220772 A1
(43) Pub. Date: Aug. 29, 2013

(54) INSTALLATION FOR PREPARING BATCHES OF PRODUCTS, OF THE VIAL OR BOTTLE KIND OR THE LIKE

(71) Applicants: Michael Vasse, Octeville-sur-Mer (FR); Lionel Daniere, Octeville-sur-Mer (FR); Grégory Choplin, Octeville-sur-Mer (FR)

(72) Inventors: Michael Vasse, Octeville-sur-Mer (FR); Lionel Daniere, Octeville-sur-Mer (FR); Grégory Choplin, Octeville-sur-Mer (FR)

(73) Assignee: SIDEL PARTICIPATIONS, Octeville Sur Mer (FR)

(21) Appl. No.: 13/880,876

(22) PCT Filed: Oct. 11, 2011
(86) PCT No.: PCT/FR2011/052371

§ 371 Date: Apr. 22, 2013

(30) Foreign Application Priority Data
Oct. 28, 2010 (FR) 10 58908

(51) Int. Cl. B65G 47/52

(52) U.S. Cl. CPC B65G 47/52
USPC 198/431

(57) ABSTRACT

The installation comprises:—an upstream conveyor (2) which supplies the lines of products, and a downstream conveying system, having, between the two;—a unit (5) for regulating the flow of products and, in each lane of said unit, a conveying module (9) of the endless belt type and sets of mobile fingers (8) for controlling the advancing speed of said products. The endless belt of each conveying module (9) extends as far as the inlet of the downstream conveyor (4), and control means are provided to separately adjust the speed of the sets of fingers (8) so as to ungroup the products in accordance with two separate modes:—an ungrouping mode with selection by regulated flow (SRF) and—an ungrouping mode with selection by adjustable fingers (SAF).

### TECHNICAL FIELD OF THE INVENTION

The invention relates to an installation for preparing batches of bottle- or vial-type products or the like, in order to package them.

### TECHNOLOGICAL BACKGROUND OF THE INVENTION

Feeding a continuous stream of batches of product to packaging machines can be done automatically by means of an installation of the type described, for example, in published PCT patent application no. WO 2010/037959.

This installation is used to prepare batches from products having a circular or ovoid cross-section, such as bottles or other products, and comprises:
an upstream conveyor which continuously supplies products arranged in single file in longitudinal passages,
a conveying system arranged downstream for preparing the batches then transferring them to the packaging machine, and between the two,
a unit for regulating the flow of products, said unit comprising a device for controlling the advance and transverse alignment of said products in order to present an organized leading edge to the first downstream conveyor which performs the ungrouping, said device for controlling the advance and alignment comprising a system of regulating fingers, or stops, which are cyclically inserted into the lateral space available between two consecutive products in a same line and which advance in a continuous manner at a speed which is less than that of said downstream ungrouping conveyor.

Said installation allows preparing batches of products which are, in themselves, relatively stable and sufficiently rigid to form, downstream from the regulating fingers, a leading side which is clean, rectilinear in the transverse direction, and which allows the downstream ungrouping conveyor to perform an operation of separating lines of products, in a precise and unfailing manner. This type of installation is used more for the preparation of batches that are relatively modest in length, limited to two or three products for example.

In this type of installation, it is more complicated to prepare batches from relatively flexible products, due to the difficulty in creating a well-organized leading side exiting the regulating unit. In fact, the regulating fingers push the rows of products towards the exit of the regulating unit and, at this exit, a dead plate forms the connection between the continuous belts of each conveying module and the belt of the downstream ungrouping conveyor. This dead plate retains the products and can cause deformations in the products in the line, to the point of interfering with their alignment and destabilizing the leading side of the products.

The belt of the conveying module advances at a speed which is substantially equal to that of the regulating fingers, or even slightly below, but this belt speed is not truly controlled because said belt is subjected to forces which can cause this speed to vary.

These variations in speed may result from friction and stresses due to pressure from the products located upstream and downstream of the regulating fingers.

But these stresses may also originate from the fact that the adhesion of the belts to their drive pulley is random. Lubricants are commonly used to reduce the friction between the products and the conveying belts. These lubricants spread onto the pulleys and the belts, generating sliding phenomena that is difficult to manage and control.

However, due to improvements in production speeds and the appearance of new products which are sometimes more difficult to manipulate, users of these batch preparation machines are increasingly confronted with difficulties which they can only resolve using specific machines adapted to each case, meaning for only one or a few types of products, according to their size, stability, and capacity to retain a shape compatible with the ungrouping elements.

Each machine is then only in use intermittently, constituting a not-insignificant operating loss for the owner company.

### GENERAL DESCRIPTION OF THE INVENTION

The invention proposes a multipurpose installation which offers the possibility of choosing a mode for ungrouping products according to multiple criteria, and in particular criteria related to the nature of the products, their size, their composition, and criteria which are related to the shape and size of the batches to be formed with these different products.

The installation for preparing batches of bottle-type or other products, according to the invention, comprises:
an upstream conveyor which supplies lines of products, and a conveying system located downstream comprising a downstream preparation conveyor topped with a conveyor system with bars;
a unit for regulating the flow of products, placed between said upstream conveyor and said downstream conveyor, said regulating unit comprising passages for each line of products, each passage being delimited by walls which are guided on rails arranged transversely, and, in each passage, an endless belt type of conveying module and sets of mobile regulating fingers for controlling the speed at which said products advance in each passage, said sets of fingers being divided into two interleaved families controlled separately by appropriate drive elements to allow adjusting the distance separating consecutive sets of fingers and to define the position of said products, a support which can be guided transversely being associated with each of the conveying modules,
   and in an essential arrangement of the invention, the endless belt of each conveying module extends all the way to the inlet of said downstream conveyor, and control means are provided for separately adjusting the speed of each of the two families of sets of regulating fingers and for adjusting, in particular, the speed of said downstream conveyor, so as to achieve two ungrouping modes for said products:—a mode referred to as selection by regulated flow (SRF), and—a mode referred to as selection by adjustable fingers (SAF).

Still according to the invention, the upper active side of the belt of the endless conveying module extends for a length which is on the order of 2 to 3 times the distance traveled by a set of fingers during the phase where said set is projecting into the passages of the regulating unit, above said active side.

In another arrangement of the invention, each conveying module comprises a first so called “sabre” roller, the endless belt of each conveying module winding over the first “sabre” roller of the same module and the belt of the downstream conveyor winding over a second “sabre” roller, so as to limit the risk of destabilizing and unbalancing the products as they pass from said endless belt to said downstream belt.

Still according to the invention, the endless belt of each conveying module is in the form of a notched belt, said notched belt being driven by a pulley that is also notched in order to guarantee the speed Vc at which the products advance when, in one of the ungrouping modes, they are released by the corresponding set of fingers, in the downstream portion of the passages of the regulating unit.

In another arrangement of the invention, said first “sabre” roller located at the downstream end of the conveying module consists of a notched roller of small diameter, said diameter being on the order of 10 to 15 mm, offering an overall radius, including the belt, which is on the order of 7 mm.

Still according to the invention, the installation comprises, in each conveying module, an endless belt driven by a servomotor able to set multiple advancement speeds according to the intended ungrouping mode, and in particular:
in an ungrouping mode referred to as SRF, a speed Vc equal to the speed of the set of regulating fingers which when active is in a product retention position, and less than the speed Va of the downstream conveyor, said downstream conveyor performing the separation of the rows of products and a cycling system with bars performing the grouping, if there is such, of said rows to form said batch of products,
or, in another ungrouping mode, referred to as SAF, a speed Vc greater than the speed Vd of the sets of regulating fingers, and substantially equal to the speed Va of said downstream conveyor, in order to perform the separation of the batches which are delimited by the endless belt of said conveying module, directly in the passages of the regulating unit.

In another arrangement of the invention, each conveying module comprises, upstream from its endless belt, a fixed plane, or dead plate, establishing the connection between the downstream end of the upstream conveyor and said endless belt.

Still according to the invention, the installation comprises, in the regulating unit, two families of sets of fingers each comprising two sets of fingers, and each set of fingers is installed on a crosspiece, said crosspieces being attached at their ends to drive means in the form of endless chains extending between sprockets, said sprockets being mounted on two horizontal shafts spaced apart from each other and arranged transversely, and each shaft comprising its own system for driving its family of sets of fingers, said drive elements, which are of the servomotor type, being actuated by means of a programmable logic controller with a program which takes into account the size of the products and the mode of product batch preparation in order to achieve, on the one hand, a phase difference between the two families of sets of fingers so as to accommodate the dimensions of the products as well as the dimensions of the batches of products, and on the other hand, to adjust the speed at which said sets of fingers advance in order to have this advancement speed correspond to the speeds required for each of the ungrouping modes for these products, namely the SRF mode or the SAF mode.

In another arrangement of the invention, each conveying module comprises a long and slender frame consisting of side walls and crosspieces, said frame being equipped, at each of its ends, with a base which is arranged between said side walls, each base cooperating with a centering and positioning pin which is installed on a support arranged at the corresponding end of the regulating unit.

In one particular feature, each of the supports is guided by one of the rails. Two supports may be provided per conveying module. The rail may pass through a borehole in the support.

In another particular feature, the endless belt of each conveying module winds over a first “sabre” roller of the same module, each module having an end, adjacent to the inlet to said downstream conveyor, which comprises said first “sabre” roller of the same module and where the endless belt winds in a 180° turn (thus having contact with half of the cylindrical surface of the first “sabre” roller). This arrangement improves the compactness of the installation, as supports of the conveying modules and the corresponding rail can be directly below this belt-wound end without adding addition bulk to the length, in spite of the proximity between the respective “sabre” rollers of the conveying modules and the downstream conveyor.

The invention also relates to the conveying module for an installation for preparing batches of products as detailed above, said module comprising a long and slender frame supporting an endless belt in the form of a notched belt and a dead plate arranged upstream from said belt, said belt winding, at the end opposite said dead plate, over a “sabre” roller in the form of a notched roller of small diameter, on the order of 10 to 15 mm.

In another arrangement of the invention, the conveying module comprises, on the side of the “sabre” roller in the form of a notched roller, a notched pulley for driving the notched belt, said notched pulley comprising a central borehole having a multi-sided shape that cooperates with a drive shaft having an appropriate cross-section and in particular a removable drive shaft which allows disassembling and changing each conveying module as needed, whether because said modules need to be changed in order to use modules of a width appropriate for the dimensions of the products or simply due to the maintenance requirements of said modules.

### BRIEF DESCRIPTION OF DRAWINGS

To enable its execution, the invention is detailed in a sufficiently clear and complete manner in the following description and the accompanying drawings, in which:

FIG. 1 is a schematic elevated view of the installation for a first mode of ungrouping and preparing batches of products, the “SRF” mode (Selection by Regulated Flows);

FIG. 2 is a schematic elevated view of the unit for regulating flows of products, showing the main component elements of this regulating unit;

FIG. 3 shows more details of the arrangement of the downstream end of the conveying module relative to the inlet to the downstream conveyor and, in particular, the “sabre” roller which is arranged at the inlet of said downstream conveyor;

FIG. 4 is a schematic elevated view of the installation for a second mode of ungrouping and preparing batches of products, the “SAF” mode (Selection by Adjustable Fingers);

FIGS. 5 to 7 show diagrams illustrating the evolution in the position and speeds of the various sets of fingers of the regulating unit;

FIG. 8 is a partial perspective view of the regulating unit, showing the placement of a portion of its primary elements;

FIG. 9 is a perspective view of one of the conveying modules according to the invention, used in the composition of the regulating unit;

FIG. 10 is a cross-sectional view of the conveying module represented in FIG. 9, with the addition of supports arranged at each of its ends; and

FIG. 11 is a detailed perspective view of one of the supports of a conveying module.

### DESCRIPTION OF PREFERRED EMBODIMENTS OF THE INVENTION

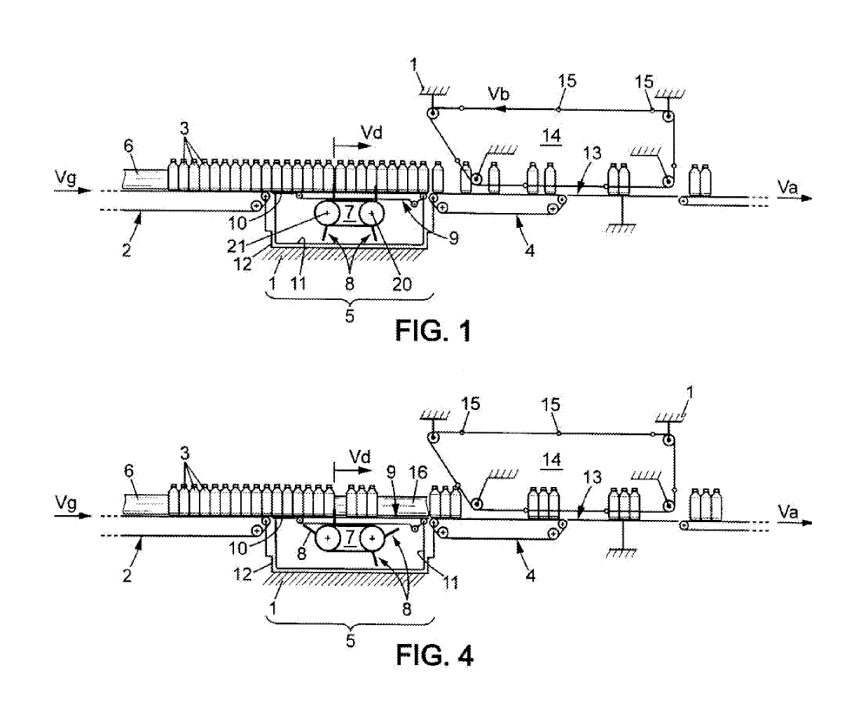

The installation represented in FIG. 1 comprises a general frame 1 onto which are assembled:
an upstream feeder conveyor 2 which has an endless belt and which conveys in a continuous manner and at a speed Vg a stream of products 3 and in particular of products having a circular or oval cross-section, or having facets, such as for example bottles, vials, etc.;
a downstream conveying system which in particular comprises a downstream preparation conveyor 4, or supplying conveyor, which has an endless belt and which advances at a speed Va and which moves the batches of products towards a packaging machine, or other, not represented, and,
a regulating unit 5 between said upstream conveyor and said downstream conveyor 4, said regulating unit controlling the speed at which the stream of products 3 advances.

These products 3 arrive in multiple lines at the upstream conveyor 2; they are guided by walls 6 which delimit passages, and these products then pass through the regulating unit 5, also in passages, specifically passages arranged to provide a very high precision in the guidance of the products, as detailed in said PCT application.

This regulating unit 5 is in the form of an interchangeable tool which comprises means for controlling and setting the speed at which products 3 pass between the upstream conveyor 2 and the downstream conveyor 4, said means consisting of a conveying system 7 comprising sets of regulating fingers 8 acting as stops and consisting of several conveying modules 9 which extend longitudinally within each passage of the regulating unit 5, between the dead plate 10 which is located at the entrance of said regulating unit 5, and the downstream conveyor 4.

The sets of regulating fingers 8 will be described below in more detail; these fingers 8 bar the passage of the products 3, acting as stops, and are mobile in order to accompany and define the position of the products 3, which in general are pressed into the regulating unit 5 by the upstream conveyor 2. The speed Vg of the upstream feeder conveyor 2 is always greater than the speed Vd of the regulating fingers 8.

The set of component elements of the regulating unit 5 is assembled onto a frame 11 and this frame 11 is integrated with the general frame 1 of the installation, positioned in a cradle 12 specifically arranged in said general frame 1.

Still in FIG. 1, one will note a general downstream conveying system which comprises:—the downstream conveyor 4,—the dead plate 13 which follows it, and, above this,—an orbital-type conveying device referred to as a cycling system 14 which comprises bars 15, said bars 15 grouping the rows of products 3 and forming batches, as detailed in said PCT application.

The installation represented in FIG. 1 corresponds to a particular mode for forming batches, said mode being referred to as selection by regulated flow, as stated above, or SRF in the description that follows.

In this SRF mode, the stream of products 3 is regulated and controlled by the fingers 8 and by the conveying module which advances at a speed Vc which is on the same order as the speed Vd of the fingers, substantially lower. Thus, when the products reach the end of the regulating unit 5, and in particular the end of the conveying module 9, each row is captured by the downstream conveyor 4 having a speed Va which is greater than the speed Vd of the fingers 8 as well as the speed Vc of the conveying module 9.

The rows of products are then taken control of by the cycling system 14 and in particular by its bars 15. The bars 15 advance at a speed Vb which is substantially greater than the speed Va of the downstream conveyor so as to group, as necessary, the rows of products 3 which are slotted between two bars 15 as the operation proceeds of ungrouping the rows which arrive at the exit of the regulating unit 5.

This SRF mode, represented in FIG. 1, corresponds to the mode of preparing batches which is described in said PCT application.

However, as detailed below, the conveying module 9 installed in the regulating unit 5 presents novel characteristics which allow performing another mode of preparing batches of products 3 in this same installation. Said mode, referred to as selection by adjustable fingers or SAF, allows the preparation of batches of products 3 which may be greater in length and in particular the preparation of batches of products 3 which are, for example, less rigid than those prepared by the SRF mode described above.

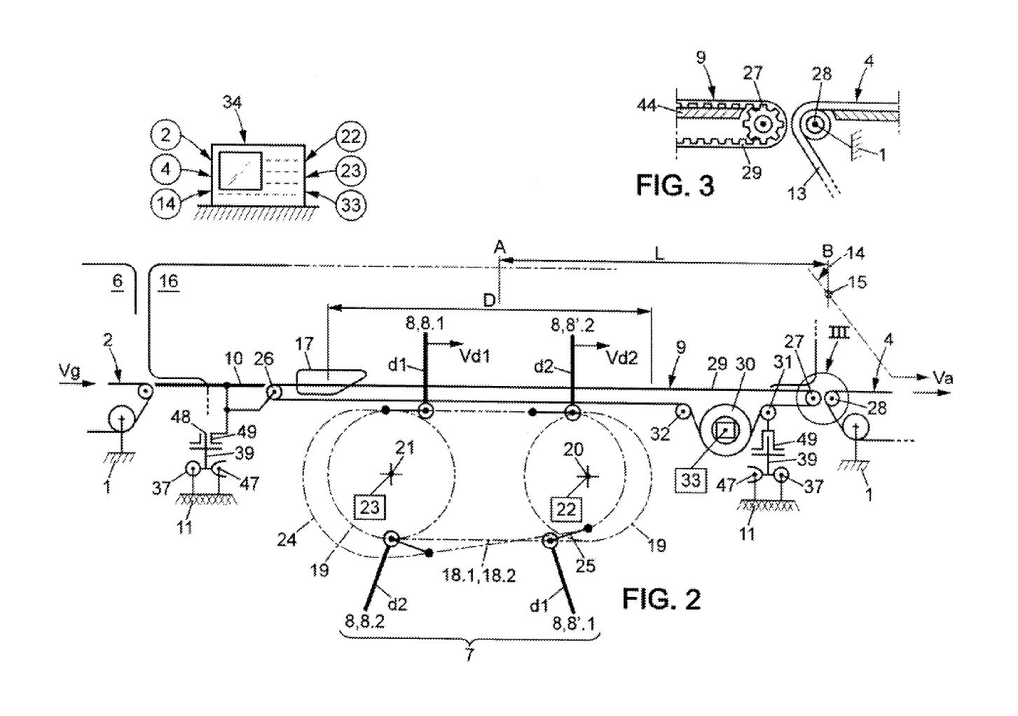

FIG. 2 shows further details of the elements of the regulating unit which come into play in order to provide the general installation for preparing batches this possibility of preparing batches according to the products 3 and according to the dimensions and shapes of the batches to be prepared, said preparation occurring by choosing either the SRF mode, illustrated in FIG. 1, or the SAF mode, illustrated in FIG. 4, depending on the case.

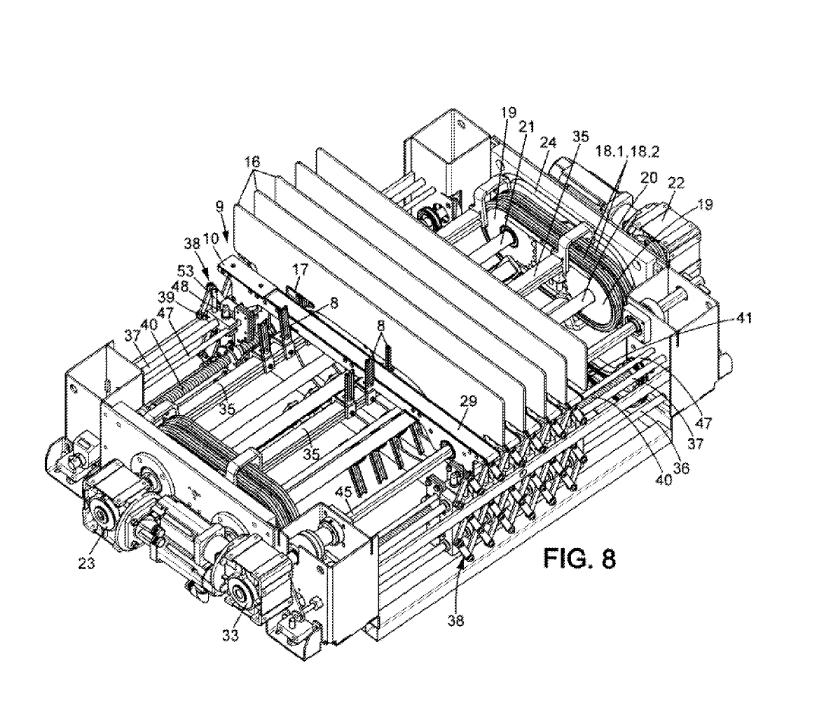

In FIG. 2, one can see the upstream conveyor 2 and the downstream conveyor 4 with, between the two, the elements of the regulating unit 5 and in particular the conveying module 9 and the dead plate 10 which forms the connection between said upstream conveyor 2 and the inlet to said conveying module 9. Walls 16 delimit the passages of the regulating unit 5; these walls 16 are positioned as an extension of the walls 6 delimiting the passages of the upstream conveyor 2. These walls 16 can comprise, as represented in FIGS. 2 and 8, a window 17 which is located at the inlet to the conveying module 9. This window allows monitoring the area where the fingers 8 are placed between two consecutive products 3.

Under the conveying module 9 is located the conveying system 7 comprising the sets of fingers 8. This conveying system, as described in said PCT application, comprises two families of sets of fingers 8 and in each family there is a pair of sets of fingers 8 which are denoted 8.1, 8.1′ for the family d1 and a pair of sets of fingers 8 which are denoted 8.2 and 8′.2 for the family d2. All these sets of fingers 8 are arranged transversely and the families d1 and d2 are interleaved, meaning each set of fingers of one family is arranged between the sets of the other family.

The pair of sets of fingers 8.1, 8′.1 is driven by an endless chain system 18, and more specifically by a system of chains denoted 18.1 in FIG. 8; these chains 18.1 are arranged laterally in the regulating unit 5, extending between sprockets 19 which are arranged on two shafts 20 and 21 parallel to each other, said shafts 20 and 21 extending transversely in the regulating unit 5, under the conveying modules 9. The chains 18.1 and the pair of sets of fingers 8.1 and 8′.1 are driven by a servomotor 22 which cooperates, for example, with the sprockets 19 by means of the shaft 20.

In the same manner, the pair of sets of fingers 8.2, 8′.2, is associated with chains 18.2 extending between other sprockets 19 and driven by a servomotor 23 by means of the shaft 21. The advancement of the sets of fingers 8 and their speed Vd1 and Vd2 results from the movements of their respective drive chains 18.1 and 18.2.

The orientation of these fingers 8 results from their guidance by means of a cam 24 having the profile represented with dotted lines in FIG. 2. A cam follower, supported by an arm 25, follows the profile of the cam 24 to give a vertical orientation to the sets of fingers 8 as they are introduced between the products 3, at the inlet to the conveying module 9, and during their withdrawal, said withdrawal, in SRF mode, occurring in a vertical position, while in the SAF mode the withdrawal consists of a rapid forward motion in order to release the leading side of the batch of products and then a vertical motion to free the way for said batch of products which are ungrouped by the speed of the conveying module 9.

As indicated above, all these elements are also found in FIG. 8 which will be described below.

The conveying module 9 comprises an endless belt which extends between a roller 26 arranged upstream and a roller of very small diameter, generally called a “sabre” roller, arranged in the downstream portion. This “sabre” roller 27 faces the “sabre” roller 28 of the downstream conveyor 4, as is represented in more detail in FIG. 3.

The endless belt of the conveying module 9 is in the form of a notched belt 29 in FIG. 3. This belt 29 is driven, on its lower inactive side, by a pulley 30 which is arranged in the downstream portion of said module 9, between two rollers 31 and 32 which guide said belt 29 in winding over a section which corresponds to approximately half the circumference of said pulley 30.

This pulley 30 is located at the “sabre” roller 27 end, and is driven by a servomotor 33.

The different servomotors for driving the sets of fingers 8, meaning servomotors 22 and 23, and the servomotor 33 for driving the conveying module 9, are controlled via a programmable logic controller 34 in order to adjust their speed to requirements. Similarly, the programmable logic controller 34 specifically controls the speeds of the conveyor 4 and of the cycling system 14 which are part of the conveying system located downstream of the regulating unit 5, and does so as a function of the speed of the conveyor 2 located upstream.

One will also note, in this FIG. 2, that the conveying module 9 is simply placed on the frame 11 of the regulating unit 5. This conveying module 9 and its means of connecting to the frame 11 will be detailed below in relation to FIGS. 8 to 11.

FIG. 3 shows more details of the downstream end of the conveying module 9 and the upstream end of the downstream conveyor 4. The notched belt 29 is driven by the pulley 30, which is notched as well. At the downstream end of the module 9, this notched belt 29 winds over the “sabre” roller 27 which is in the form of a notched roller of very small diameter; the diameter of this roller 27 is between 10 and 15 mm, for example. With the belt 29, the total radius at the end of the conveying module 9 is 7 mm for example.

In the same manner, the upstream end of the downstream conveyor 4 comprises a “sabre” roller 28 in the form of a roller having a diameter which is also on the order of 10 to 15 mm, and over which the belt of said conveyor 4 winds. The radius measured at the inlet to this conveyor 4 is preferably also on the order 7 mm.

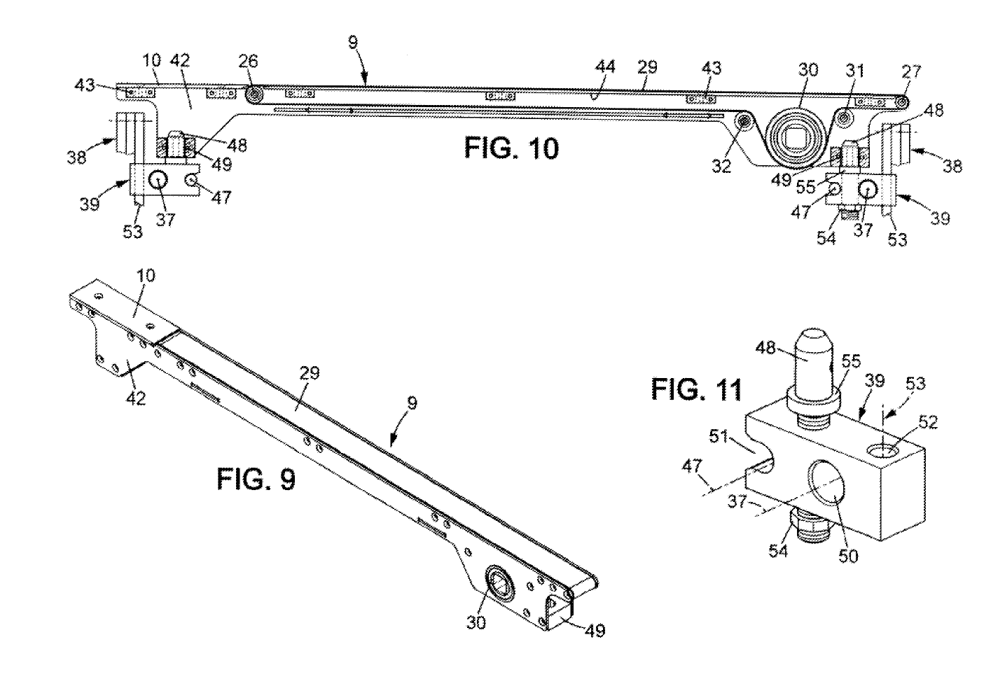

This arrangement of the ends of the module 9 and of the downstream conveyor 4, involving “sabre” rollers of very small diameter, limits the unbalancing of the products 3 at this discontinuity in the guiding surface; this type of discontinuity is generally resolved by installing a dead plate, as is the case upstream of the module 9. As is clearly visible in FIGS. 2 and 3 (see also FIGS. 9-10), at the end near the downstream conveyor 4, the belt 29 of the module 9 winds in a 180° turn.

The specific characteristics of this SAF mode require different speeds in the various conveying systems than those of the SRF mode. Thus, the speed Vc of the notched belt 29 of the module 9 is equal to the speed Va of the downstream conveyor 4.

In effect, as represented in FIG. 4, the separation of the products 3 to form a batch occurs in the regulating unit 5. The speed of the notched belt 29 is greater than the speed Vd of the fingers 8 such that the separation of the products occurs within the regulating unit 5 and no longer at its downstream end as is the case for the SRF mode as represented in FIG. 1.

The batches of products prepared using the SAF mode are taken up by the downstream conveyor 4 and may also be taken charge of by the cycling system 14 and in particular by its bars 15 in order to compact them longitudinally and, depending on the case, transversely by means of guides, not represented, positioned between the conveyor 4 and the lower side of the cycling system 14 of the downstream conveying system, or above the level of said bars 15.

For the SAF mode, the batches are prepared by different sets of fingers 8. The interval between two sets of fingers 8, 8.1 and 8.2 for example, as represented in FIG. 4, corresponds to the number of rows 3 constituting the batch. This interval can range from 75 to 300 mm for example.

The delimited batch is managed on the fly between the consecutive sets of fingers 8; when a set of fingers 8 is in the active position of retaining the flow of upstream products, the downstream set of fingers can slip away, releasing the batch of products, and due to the difference in speeds between the speed Vc of the notched belt 29 and Vd, said batch moves rapidly away from the leading side of the products 3 retained by the set of active fingers 8, thus separating the batches. The batches are then taken up by the downstream conveyor 4 and, if applicable, by the cycling system 14.

The servomotors 22 and 23 therefore have several functions. Firstly, these servomotors 22 and 23 are used to establish an initial distance Dd between two sets of fingers, for both the SRF mode and the SAF mode, and they also allow, when one of the sets in which the fingers are active and advancing at an intended normal operating speed, accelerating the movement of the inactive sets of fingers in order to reposition the first set to take over for said active fingers, by inserting said previously inactive fingers into the stream of products 3, at the position intended for this purpose, whether this means a position for controlling the flow as in the SRF mode or in a specific position which corresponds to the length of the batch, as in the SAF mode.

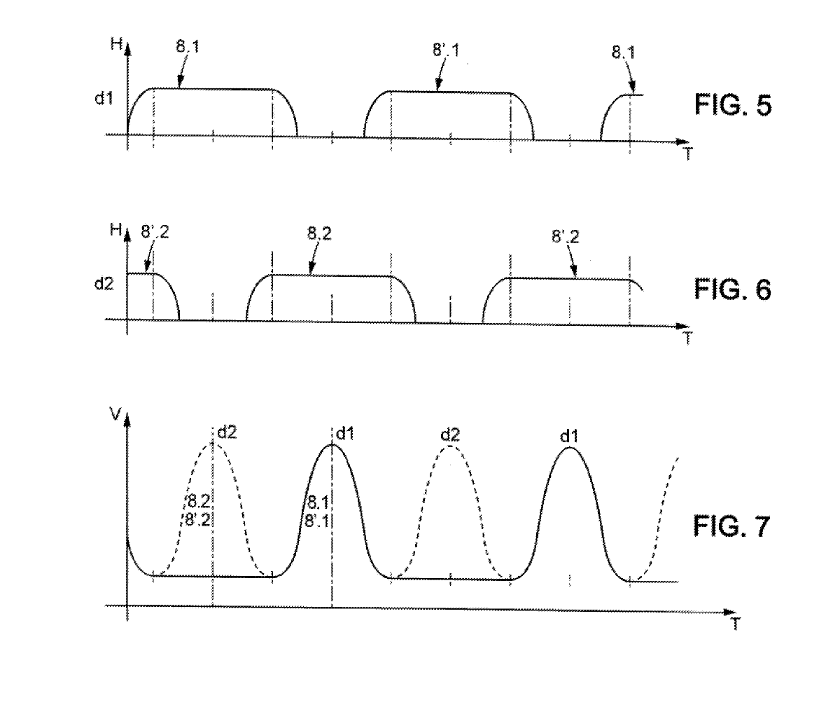

FIGS. 5 and 6 are diagrams of the active positions of the sets of fingers 8, with the position of the upper end of each finger relative to the notched belt 29 of the conveying module 9 on the y axis, and with the time on the x axis.

Thus, in FIG. 5, for the family dl which comprises the sets of fingers 8.1 and 8′.1, one will first note the placement in the active position of the set of fingers 8.1 which corresponds to a given period of time and, between the active position of the finger 8.1 and the active position of the fingers 8′.1, one will note an interval of inactivity which is covered by one of the sets of fingers in the second family d2 and in particular the set of fingers 8.2.

The stream of products 3 is therefore constantly retained and controlled by one of the sets of fingers 8 of each family d1 and d2. The spacing between two consecutive sets of fingers 8 can vary, for example from 75 to 300 mm, as indicated above.

FIG. 7 shows, again in diagram form, the evolution in the speed of the sets of fingers 8 of each family, relative to their positions as represented in FIGS. 5 and 6. The sets of fingers 8.1 and 8′.1 of family d1 are represented as a solid line while the sets of fingers 8.2 and 8′.2 of family d2 are represented as dotted lines. Thus, when the set of fingers 8.1 is in the active position, its speed is stable and uniform as is that of set 8′.1 which is part of the same family. As soon as the set of fingers 8.2 reaches the active position in order to take over for the set of fingers 8.1, the set of fingers 8.1 retracts at a very high acceleration and a significant speed in order to reposition themselves and, in particular, to hold the set of fingers 8′.1 in the active position before the retraction of the set of fingers 8.2.

The diagrams in FIGS. 5 and 7 correspond primarily to an operation of the regulating unit 5 according to the SAF mode. In the case of the SRF mode, the spacing between the two families of sets of fingers can be more regular; in practice, however, it is adjusted at each new introduction in order to coordinate the set of fingers with the spaces between two consecutive products 3.

In the case of the SAF mode, in order to achieve rapid ungrouping of the batches, the upstream fingers must be retracted very quickly, as soon as the following downstream fingers are in the active position where they are able to control the advancement of the stream of products to be used to form the next batch.

The length L of the portion of the conveying module 9 where the notched belt 29 carries the batch of products at a speed greater than the speed at which the leading side of the products retained by the set of active fingers 8 advances, is on the order of one to one and a half times the distance D traveled by a set of fingers 8 when these fingers are projecting into the passages where the products circulate, as represented in FIG. 2. This length L corresponds in fact to the distance between point A where, in the SAF mode, the set of fingers 8 releases the batch of products, and the point B which corresponds to the location where the batches of products are taken charge of by the bar 15 which arrives in the vicinity of the downstream end of the conveying module 9.

FIG. 8 diagrams a regulating unit 5 according to the invention. This unit comprises a frame 11 onto which are installed the servomotors 22 and 23 which respectively serve to drive the families of sets of fingers 8. A first family d1 of sets of fingers 8 is installed on crosspieces 35 which are supported and driven by the laterally arranged endless chains 18, said endless chains being extending between the sprockets 19; each chain 18 is associated with a family d1 or d2 of sets of fingers 8 and each chain 18 is driven by its own servomotor 22 or 23, in an autonomous manner by means of the programmable logic controller 34.

The fingers 8 surround each conveying module 9 and in particular the endless belt consisting of the notched belt 29 and these fingers 8, which are in the form of tines; they straddle the walls 16 delimiting the various passages where the streams of products 3 circulate.

The walls 16 are guided on transversely arranged rails 36 and 37 and they are manipulated by means of a pantograph system 38 to allow appropriate adjustment of their width according to the dimensions of the products 3 to be grouped into batches. As they move, the walls 16 automatically move the fingers 8, said fingers 8 being slidingly mounted on the crosspieces 35.

The conveying modules 9 are installed on supports 39 which are directly connected to the pantograph system 38 in order to ensure that said modules 9 are automatically centered in each passage between the walls 16, when the width of each of the passages is adjusted.

The distance between the walls 16 is adjusted by means of a screw-nut system; a screw 40 is arranged on each side of the conveying unit 5, at its entrance on the upstream end and at its exit on the downstream end, and the movement of the two screws 40 is coordinated by means of a chain transmission 41.

The conveying modules 9 are represented in more detail in FIGS. 9 and 10. Each module 9 comprises a long and slender frame which consists of two side plates 42, said plates being cut in the shape of a bridge in order to follow the shape of the path of the crosspieces 35 supporting the sets of fingers 8. These two plates 42 are attached by means of spacers 43 which in the upstream portion support the dead plate, and for the rest of the length of the module, support a plate 44 which serves as a guiding surface for the active upper side of the notched belt 29.

The length of the upper active side of the notched belt 29 is on the order of 2 to 3 times the distance traveled by a set of fingers 8 during the phase where said fingers 8 are projecting into the passages guiding the products to be ungrouped.

The downstream end of the conveying module 9 comprises the “sabre” roller 27 in the form of notched roller having its axle supported by the plates 42, similarly to the rollers 31 and 32 which serve to guide the path of winding of the notched belt 25. One of the rollers, roller 32 for example, can serve as a tensioning roller for the notched belt 29.

The pulley 30 driving the belt 29 is also supported and guided between the plates 42. This pulley 30 comprises a hub arranged to cooperate with a shaft having a square cross-section for example, said shaft 45, driven by the servomotor 33, being arranged for threading through the hub of the various pulleys 30 of each conveying module 9, said pulleys 30 being in alignment for the entire width of the conveying unit 5. This shaft 45 is removable to allow easy release of the set of conveying modules 9.

In effect, as already indicated in relation to FIG. 2, the conveying modules 9 are in the form of tools; they are specifically adapted to the dimensions of the products 3 to be conveyed. These modules 9 are easily disassembled; they are simply placed at each of their ends onto the support 39 which is connected to the pantograph system 38, in order to be displaced simultaneously with the walls 16 when the width of the passages is adjusted.

Each support 39 is guided on the upper rail 37 which serves to guide the walls 16, and on a rail 47 which is specific to it and which serves to maintain it in the appropriate position. The support 39 comprises a vertical pin in its upper portion which cooperates with a base 49 arranged in the lower portion and at each end of the conveying modules 9. This base 49, held tightly between the plates 42, comprises a cylindrical or oblong borehole to accept the pin 48 of the corresponding support 39.

As represented in FIG. 11, the support 39 is in the form of a block comprising several arrangements:—a borehole 50 to allow the passage of the rail 37,—a groove 51 to allow the passage of the rail 47, and—a borehole 52 to allow the passage of a rail 53, visible in FIG. 10 in particular, which is guided by the pantograph system 38.

The pin 48 preferably comprises a lower threaded part, as represented in FIG. 11, which cooperates with a threading created in the support 39. A lock nut 54 sets the position of the pin 48 and, in particular, its shoulder 55 which serves to support and position the base 49 of the conveying module 9. This pin 48 with its shoulder 55 is preferably used on the downstream side of the regulating unit 5, in order to adjust with maximum precision the position of the downstream end of the conveying module 9 relative to the inlet to the downstream conveyor 4; this involves placing the “sabre” rollers 27 of each module 9 in correspondence with the “sabre” roller 28 of the downstream conveyor 4, in order to avoid unbalancing the products during their travel from one to the other.

1-13. (canceled)

14. An installation for preparing batches of bottle-type products, said installation comprising:
an upstream conveyor which supplies lines of products, and a conveying system located downstream comprising a downstream preparation conveyor topped with a cycling system with bars;
a regulating unit for regulating the flow of products, placed between said upstream conveyor and said downstream conveyor, said regulating unit comprising passages for each line of products, each passage being delimited by walls which are guided on rails arranged transversely, and, in each passage, an endless belt type of conveying module and sets of mobile regulating fingers for controlling a speed at which said products advance in each passage, said sets of fingers being divided into two interleaved families controlled separately by drive elements to allow adjusting a distance separating said consecutive sets of fingers and to define the position of the products, a support which can be guided transversely being associated with each conveying module, wherein an endless belt of each conveying module extends all the way to an inlet of said downstream conveyor, and control means are provided for separately adjusting the speed of each of said two families of sets of regulating fingers and for adjusting the speed of said downstream conveyor, so as to achieve two ungrouping modes for said products.

15. The installation according to claim 14, wherein each conveying module comprises a first roller, said endless belt of each conveying module winding over said first roller of said conveying module and a belt of said downstream conveyor winding over a second roller, so as to limit the risk of destabilizing and unbalancing the products as the products pass from said endless belt to said belt of said downstream conveyor.

16. The installation according to claim 15, wherein said endless belt of each conveying module is in the form of a notched belt, said notched belt being driven by a pulley that is also notched in order to guarantee the speed Vc at which the products advance when, in one of said ungrouping modes, the products are released by the corresponding set of fingers, in a downstream portion of said passages of said regulating unit.

17. The installation according to claim 16, wherein said first roller, located at said downstream end of said conveying module, comprises a notched roller of small diameter, said diameter being on the order of 10 to 15 mm, offering an overall radius, including said notched belt, which is on the order of 7 mm.

18. The installation according to claim 14, comprising, in each conveying module, said endless belt driven by a servomotor able to set multiple advancement speeds according to the intended ungrouping mode, and:
in a first ungrouping mode, referred to as SRF, a speed Vc equal to the speed of a set of regulating fingers which when active is in a product retention position, and less than the speed Va of said downstream conveyor, said downstream conveyor performing the separation of rows of products and said cycling system with said bars performing the grouping, if there is such, of said rows to form said batch of products,
or, in a second ungrouping mode, referred to as SAF, a speed Vc greater than the speed Vd of said sets of regulating fingers, and substantially equal to the speed Va of said downstream conveyor, in order to perform the separation of the batches which are delimited by said endless belt of said conveying module, directly in said passages of said regulating unit.

19. The installation according to claim 14, wherein each conveying module comprises, upstream from said endless belt of said conveying module, a dead plate, establishing the connection between a downstream end of said upstream conveyor and said endless belt.

20. The installation according to claim 14, comprising, in said regulating unit, two families of sets of fingers each family comprising two sets of fingers, and each set of fingers being installed on a crosspiece, the crosspieces being attached at two ends to drive means in the form of endless chains extending between sprockets, said sprockets being mounted on two horizontal shafts spaced horizontally apart from each other and arranged transversely, and each shaft comprising an own drive system for driving a corresponding family of sets of fingers said drive elements, of the servomotor type, being actuated by means of a programmable logic controller with a program which takes into account the size of the products and the mode of product batch preparation in order to achieve, on the one hand, a phase difference between said two families of sets of fingers so as to accommodate the dimensions of the products as well as the dimensions of the batches of products, and on the other hand, to adjust the speed at which said sets of fingers advance in order to have the advancement speed correspond to the speeds required for each of said ungrouping modes for the products, namely the SRF mode or the SAF mode.

21. The installation according to claim 14, wherein each conveying module comprises a long and slender frame comprising side walls and crosspieces, said frame being equipped, at each of two ends, with a base which is arranged between said side walls, each base cooperating with a centering and positioning pin which is installed on a corresponding support arranged at the corresponding end of said regulating unit.

22. The installation according to claim 14, wherein each of the supports is guided by one of rails respectively.

23. The installation according to claim 22, wherein said rail passes through a borehole in said support.

24. The installation according to claim 14, wherein said endless belt of each conveying module winds over a first roller of the same conveying module, each conveying module having an end, adjacent to an inlet to said downstream conveyor, which comprises said first roller of said same module and where said endless belt winds in a 180° turn.

25. A conveying module for an installation for preparing batches of bottle-type products comprising:
an upstream conveyor which supplies lines of products, and a conveying system located downstream comprising a downstream preparation conveyor topped with a cycling system with bars;
a regulating unit for regulating the flow of products, placed between said upstream conveyor and said downstream conveyor, said regulating unit comprising passages for each line of products, each passage being delimited by walls which are guided on rails arranged transversely, and, in each passage, an endless belt type of conveying module and sets of mobile regulating fingers for controlling a speed at which said products advance in each passage, said sets of fingers being divided into two interleaved families controlled separately by drive elements to allow adjusting a distance separating said consecutive sets of fingers and to define the position of the products, a support which can be guided transversely being associated with each conveying module, wherein an endless belt of each conveying module extends all the way to an inlet of said downstream conveyor, and control means are provided for separately adjusting the speed of each of said two families of sets of regulating fingers and for adjusting the speed of said downstream conveyor, so as to achieve two ungrouping modes for said products,
the conveying module comprising a long and slender frame supporting an endless belt in the form of a notched belt and a dead plate, said notched belt winding, at an end opposite said dead plate, over a roller in the form of a notched roller of small diameter, on the order of 10 to 15 mm.

26. The conveying module according to claim 25, comprising, on the side of said roller in the form of a notched roller, a notched pulley for driving said notched belt, said notched pulley comprising a central borehole having a multi-sided shape that cooperates with a drive shaft having a corresponding cross-section and which is a removable drive shaft which allows disassembling and changing each conveying module as desired and as needed.
